(19) United States
(12) Patent Application Publication
(10) Pub. No.: US 2016/0245655 A1
(43) Pub. Date: Aug. 25, 2016

(54) ADJUSTED NAVIGATION

(71) Applicant: NEDERLANDSE ORGANISATIE VOOR TOEGEPAST-NATUURWETENSCHAPPELIJK ONDERZOEK TNO, 's-Gravenhage (NL)

(72) Inventor: Marcel Gregorius Anthonius Ruizenaar, 's-Gravenhage (NL)

(21) Appl. No.: 15/029,799

(22) PCT Filed: Oct. 17, 2014
(86) PCT No.: PCT/NL2014/050727

§ 371 Date: Apr. 15, 2016

(30) Foreign Application Priority Data
Oct. 18, 2013 (EP) 13189228.3
Jul. 16, 2014 (EP) 14177304.4

(51) Int. Cl. G01C 21/16; G01C 25/00

(52) U.S. Cl. CPC G01C 21/165; G01C 25/00

(57) ABSTRACT

A navigation device (1) comprises:
a navigation state estimation unit (11) for repeatedly providing a navigation state estimate comprising at least one of the position, the velocity and the attitude of the device,
a prediction unit (12) for providing, using the navigation state estimate, a predicted magnetic property value,
a storage unit (13) for retrieving, using the navigation state estimate, a previously stored magnetic property value,
a subtraction unit (14) for producing the difference of the predicted magnetic property value and the retrieved magnetic property value,
a filter unit (15) for producing, using said difference, a navigation state correction value, and
a correction unit (16) for correcting, using said navigation state correction value, a corrected navigation state estimate.

The prediction unit (12) comprises:
a magnetic measuring unit for repeatedly providing a measured magnetic field strength value, and
an integrating unit for integrating the measured magnetic field strength values to produce the magnetic property value corresponding with the navigation state estimate.

### BACKGROUND OF THE INVENTION

The present invention relates to adjusted navigation. More in particular, the present invention relates to a method and a device for adjusting the navigation state determined by navigation systems, especially but not exclusively inertial navigation systems. The present invention particularly relates to a method and a device for providing adjusted or corrected navigation states.

Navigation systems are designed to determine their position, and optionally other variables such as velocity, at a certain point in time. Systems such as GPS (Global Positioning System) determine their position with the aid of external references, that is, the locations of satellites. Inertial navigation systems use inertia referenced sensors like accelerometers and gyroscopes, also known as inertial sensors, to determine movements relative to a starting position. The output of an inertial navigation system (such as position, velocity etc.) is determined by numerically integrating in time the inertial sensor output. As inertial sensors always introduce errors, however small, the position determined by the system tends to increasingly deviate from the real position as time progresses. For this reason, the navigation states produced by inertial navigation systems need to be adjusted from time to time.

U.S. Pat. No. 8,700,326 and its European counterpart EP 2504664 (TNO), which are herewith incorporated in this document, disclose a navigation system provided with a magnetic field sensor unit arranged for providing a magnetic field signal indicative of a magnetic field strength. This known system comprises an integration unit for calculating a path-integral of the magnetic field signal so as to produce a value which is related to its position. The known system is arranged to exchange data with a similar system when they are at approximately the same location, that is, when they encounter each other. The exchanged data allow the systems to determine their locations and to correct navigation errors. The system of

U.S. Pat. No. 8,700,326 is very useful but requires at least two similar systems to encounter each other in order to produce a position update.

United States Patent Application US 2013/0179075 (Indooratlas) discloses an apparatus for determining a position inside a building. This known device first uses a non-magnetic field based location system to determine a location estimate and then uses an Earth magnetic field measurement and an Earth magnetic field map to further determine the location estimate. This known device has the disadvantage that it is less accurate in situations where the magnetic field is highly uniform. Further, the location estimate of this known device is highly correlated to the location estimate of the non-magnetic field based location system. Further use of this location to correct Inertial navigation systems is therefore not possible.

### SUMMARY OF THE INVENTION

It is an object of the present invention to overcome these and other problems of the Prior Art and to provide a navigation adjustment method and system which is capable of operating independently, that is, which does not require a second system to provide a navigation update but which still has a high accuracy.

Accordingly, the present invention provides a navigation device, comprising:
a navigation state estimation unit for repeatedly providing a navigation state estimate, said navigation state comprising at least one of a position, a velocity and an attitude of the device,
a prediction unit for providing, using the navigation state estimate, a predicted magnetic property value,
a storage unit for retrieving, using the navigation state estimate, a previously stored magnetic property value,
a subtraction unit for producing the difference of the predicted magnetic property value and the retrieved magnetic property value,
a filter unit for producing, using said difference, a navigation state correction value, and
a correction unit for producing, using said navigation state correction value, a corrected navigation state estimate,

wherein the prediction unit comprises:
a magnetic measuring unit for repeatedly providing a measured magnetic field strength value, and
an integrating unit for integrating over distance the measured magnetic field strength values to produce the magnetic property value corresponding with the navigation state estimate.
   By providing a prediction unit for providing, using the navigation state estimate, a predicted magnetic property value, and by further providing a storage unit for retrieving, using the navigation state estimate, a previously stored magnetic property value, it is possible to compare the predicted and the retrieved magnetic property values corresponding with the estimated navigation state. The comparison preferably results in a difference value which is in turn used to correct or adjust the navigation state estimate.

The filter unit preferably comprises a Kalman filter. Such filters, which are well known per se, are very suitable to produce navigation state correction values, based on a single difference value or a multiple of difference values, in the case a multiple of sensors are used. It is for instance possible to use GPS position measurements (if available) in combination with a barometer height measurement and magnetic field measurements, or any other navigation related sensor measurement, at the same time. This seamless integration with other sensors is one of the advantages of the method.

The Kalman filter is preferably updated when producing each navigation state correction value. However, in some embodiments the Kalman filter is not updated if the difference of the predicted magnetic property value and the retrieved magnetic property value substantially equals zero. That is, when the input of the Kalman filter is approximately zero, the filter is preferably no longer updated to preserve its existing state. In these cases the Kalman filter merely performs a prediction calculation (coasting).

It is further preferred that the Kalman filter is not updated if the difference of the predicted magnetic property value and the retrieved magnetic property value exceeds a threshold value. That is, if the difference is too large, it is determined that a navigation error has been made that cannot be corrected. Exceeding this threshold may advantageously be recorded and/or be brought to the attention of a user.

In a first embodiment, the difference of the predicted magnetic property value and the retrieved magnetic property value is given by

\tilde{ψ}−ψ^{table}(p\tilde{p̅}^{end})=(H̅^{avg}−H̅^{end})·\overline{\hat{p}},

where H^{avg} is the average

magnetic field strength during a measurement trajectory, H̅^{end} is the magnetic field strength at the end of the measurement trajectory, and \overline{\hat{p}} is the estimated position error. In this embodiment, the difference value is determined using the average and the final magnetic field strength, and the navigation state error.

In a second embodiment, the difference of the predicted magnetic property value and the retrieved magnetic property value is given by

\tilde{ψ} ψ^{t}(\tilde{p̅}^{e})=\overline{\hat{V}}·(∫₀^{T}H̅·dt)|\overline{\hat{α}}·(∫₀^{T}H̅·t·dt) \overline{\hat{p}}·(H̅^{end}).

where \tilde{\hat{V}} is the estimated velocity error, H̅ is the magnetic field strength during a measurement trajectory, H̅^{end} is the magnetic field strength at the end of the measurement trajectory, \overline{\hat{α}} is the acceleration error, and \overline{\hat{p}} is the position error. In this embodiment, the constant velocity error \overline{\hat{V}} taken into account.

Although the navigation state estimation unit is preferably configured for inertial navigation (INS), it may alternatively, or additionally, be configured for other dead-reckoning navigation techniques, such as odometry, step counting systems etc.

The present invention further provides a vehicle, provided with a navigation device as defined above. The vehicle may be a road vehicle, such as a car or a bicycle, but may also be an airplane, a helicopter or a ship.

The present invention additionally provides a set of vehicles arranged for, preferably wireless, data exchange, the vehicles together comprising all constituent units of the navigation device defined above, a first vehicle comprising the magnetic measuring unit and a second vehicle comprising the navigation state estimation unit. In such a set of vehicles, the navigation device is distributed over two or more vehicles, the relatively expensive magnetic measuring unit being present in the first vehicle only. The set may comprise more than one second vehicle.

In an embodiment of such a set of vehicles the magnetic measuring unit of said first vehicle is part of a first navigation device comprised in the first vehicle, and the navigation state estimation unit of the second vehicle is part of a second navigation device, according to one of the embodiment as specified above, comprised in the second vehicle, wherein said magnetic measuring unit of said first vehicle determines magnetic property values for storage in said storage unit of said second navigation device, to be used by the subtraction unit of the second navigation device for producing the difference of the predicted magnetic property value and the retrieved magnetic property value. In this embodiment the navigation system of the first vehicle prepares the magnetic property values to be used as reference data by the navigation system of the at least one second vehicle. Provided that this reference data is sufficiently accurate, the navigation state estimation unit of the second navigation devices can be less accurate, as the correction unit can sufficiently correct the navigation state estimate using the reference data. Therewith the set of vehicles only needs a first vehicle with a high quality navigation state estimation unit while a plurality of second vehicles can be used that do not need a high quality navigation state estimation unit, therewith providing for a high overall quality at relatively low costs.

The previously stored magnetic property values may be obtained by moving a suitable apparatus, preferably using a vehicle, and accurately determining its navigation state (including its position) a large number of times, for example by using GPS, triangulation involving radar and/or infra-red light, and/or other means. Such apparatus may comprise a magnetic measuring unit for repeatedly providing a measured magnetic field strength value, and an integrating unit for integrating the measured magnetic field strength values over distance to produce the magnetic property value corresponding with the determined navigation state. The magnetic property values thus found may be transferred to a suitable storage unit, such as a ROM (Read Only Memory) unit from which they can be retrieved when required.

The present invention also provides a navigation method comprising the steps of:
repeatedly providing a navigation state estimate,
providing, using the navigation state estimate, a predicted magnetic property value,
retrieving, using the navigation state estimate, a previously stored magnetic property value,
producing the difference of the predicted magnetic property value and the retrieved magnetic property value,
producing, using said difference, a navigation state correction value, and
correcting, using said navigation state correction value, a corrected navigation state estimate,

wherein the step of providing a predicted magnetic property value comprises:
repeatedly providing a measured magnetic field strength value, and
integrating the measured magnetic field strength values over distance to produce the magnetic property value corresponding with the navigation state estimate.

The step of producing a navigation state correction value may advantageously comprise Kalman filtering, which Kalman filtering preferably comprises updating a filtering state when producing each navigation state correction value. The Kalman filtering state may not be updated if the difference of the predicted magnetic property value and the retrieved magnetic property value substantially equals zero.

It is preferred that the previously stored magnetic property values are obtained by repeatedly providing a measured magnetic field strength value, and integrating the measured magnetic field strength values over distance.

In an advantageous embodiment, the step of repeatedly providing a measured magnetic field strength value is carried out in a first vehicle, and the other steps are carried out in a second vehicle, said values being transmitted from the first to the second vehicle, and the second vehicle preferably following the first vehicle. In an embodiment, the first vehicle carries the relatively expensive apparatus required to measure the magnetic field strength while the second (and possible third, fourth, etc.) vehicle need only carry relatively inexpensive navigation apparatus. The magnetic property values may be transmitted from the first to the second vehicle wirelessly, e.g. using a mobile telecommunication network.

The present invention additionally provides a computer program product for carrying out the method as defined above. A computer program product may comprise a set of computer executable instructions stored on a tangible data carrier, such as a CD, a DVD or a memory stick. The set of computer executable instructions, which allow a programmable computer to carry out the method as defined above, may also be available for downloading from a remote server, for example via the Internet.

Reference is made to the book by Paul D. Groves: “Principles of GNSS, Inertial, and Multisensor Integrated Navigation Systems”, ISBN-13: 978-1-58053-255-6, 2007, which explains navigation systems, including Kalman filters, in more detail.

### BRIEF DESCRIPTION OF THE DRAWINGS

The present invention will further be explained below with reference to exemplary embodiments illustrated in the accompanying drawings, in which:

FIG. 1 schematically shows navigation paths in accordance with the present invention.

FIG. 2 schematically shows a navigation device in accordance with the present invention.

FIG. 3 schematically shows a prediction unit of the navigation device illustrated in FIG. 2.

### DETAILED DESCRIPTION OF EMBODIMENTS

The present invention is inspired on Ampere's circuital law, which states:

[symbol]

_{C}H̅·dl̅=l

in which:

H̅ is the field strength of the local static magnetic field,

C is a closed path over which the integration is done,

dl̅ is a small element of the closed path C,

I is the net electric DC current flowing through the surface surrounded by the closed path.

In practical indoor/outdoor situations, usually no DC current flows in the space where navigation takes place. AC currents (power lines) do flow, but these do not pose a problem as their effects in general average out in time and further, power lines usually go in pairs (such that the net AC current is zero). If we apply Ampere's law to closed paths in such a space without net DC currents it then simplifies to:

[symbol]

_{C}H̅·dl̅=O

In U.S. Pat. No. 8,700,326 a method is disclosed how the accelerometer biases of multiple INS (Inertial Navigation System) can be estimated by partial evaluation of the integral in Ampere's law. This is done by detecting encounters between the navigating objects. This made the invention in general only applicable to systems with a plurality of navigating objects and depending on encounters between them.

The present invention solves this problem, making it applicable to a single navigating system. The concept is called “Amperian Navigation Correction” (ANC), referring to Ampere's law for the magneto-static field.

Notation

Bars are used to indicate vectors (example: ν̅)

A tilde is used to further indicate estimated values (example: \tilde{ν̅})

A hat is used to indicate the error of a value (example: \hat{ν̅})

Vector Subscripts & Superscripts:

Subscript b: used to denote body referenced vectors (example: ν̅_{b})

Subscript e: used to denote Earth referenced vectors (example: νₑ)

Unless explicitly denoted otherwise, vectors are always in the Earth reference system.

Superscript “table”: used to indicate a “table look-up” value

Superscript “end”: used to indicate a final or last measured value

Superscript m: used to denote a measured value

Magnetic Field B and H

Historically the “magnetic induction” or “magnetic flux density” is denoted by the letter B and the “magnetic field” is denoted by the letter H. Nowadays, the name “magnetic field” is commonly used for both the B-field and the H-field. In this document this modern naming convention will be followed, using the name “magnetic field” for both the B-field and H-field.

In the absence of DC currents in a defined space where navigation takes place, Ampere's law reduces to [symbol] _{C}H̅·dl̅=O for any closed path in that space. For this space, an unambiguous scalar potential field is defined as a function of the position p̅. The scalar potential is found by integrating over any arbitrary path C that ends in p̅. The origin position where integration starts is Ō. The scalar potential defined for the origin position is arbitrary and may be set to zero.

ψ(p̅)−∫_{Ō}^{p̅}H̅·dl̅+ψ(Ō)−∫_{Ō}^{p̅}H̅·dl̅

So as long as we define an origin position Ō and a scalar potential ψ(Ō) for that position, the scalar potential function is completely defined given a fixed magnetic field.

For the method described in this document, it is required that the magnetic field is known at locations where navigation can take place. For places where navigation will not take place, the magnetic field need not be known. Based on the known magnetic field, this scalar potential ψ(p̅) can be calculated a priori. The calculated map of the scalar potential can be stored in a (remote) database or locally in a storage unit of the navigating object.

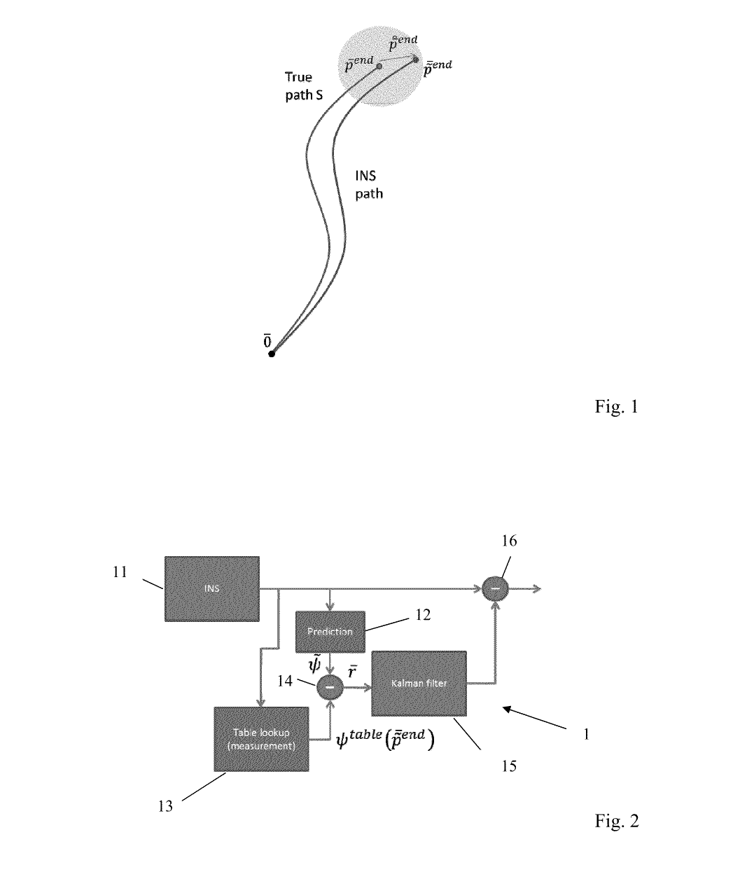

Reference is made to FIG. 1. Suppose an object is navigating over some true path S, starting in the origin Ō and taking up a travelling time T. At the end of the path, the scalar potential ψ^{table}(\tilde{p̅}^{end}) is determined by looking it up in a table, indexed by the position \tilde{p̅}^{end}, which is estimated by the INS. \tilde{p̅}^{end} deviates from the true position p̅^{end} by an error \overline{\hat{p}}^{end}.

At the true position p̅^{end} the magnetic field strength is measured B̅_{b}^{end,meas} using magnetometers. From this measurement we can derive H̅_{b}^{end,meas} using the relation

B̅_{b}^{end,meas}=μH̅_{b}^{end,meas}, )1)

with μ the permeability of the materials of the sensor and surrounding the sensor. It is assumed that non-magnetic materials are used and that navigation takes place in a non-magnetic medium (such as air) such that μ=μ₀, the permeability of free space. The measurement is done in the body axis system (or also called sensor axis system) and rotated to the Earth (or navigation) axis system using the body to Earth rotation matrix of the INS.

\overline{\tilde{H}}^{end}=R̅_{be}·H̅_{b}^{end,meas} (2)

It is assumed that in the small volume around p̅^{end} the magnetic field strength is uniform. This volume is indicated by the shaded area in FIG. 1. If the quality of the IMU (Inertial Measurement Unit) or similar navigation unit is sufficient, this condition will automatically be met. The higher the IMU quality, the lower the expected error after some time. For some applications, the homogeneity of the field can be “designed” such that this condition is met with respect to the expected error after some time. The Earth magnetic field can for instance be made non-homogeneous by placing magnets or magnetic (iron) materials in or near the space where navigation takes place, or DC current sources near the space where navigation takes place.

It is further assumed that the attitude errors of the INS are very small such that the following approximation is valid: H̅^{end}≈\overline{\tilde{H}}^{end}. Then, the scalar potential at the INS position is equal to the scalar potential at the true position plus the contribution due to the INS position error:

ψ^{table}(\tilde{p̅}^{end})=ψ^{end}+H̅^{end}·\overline{\hat{p}} (3)

During the travelling time T, the scalar potential is also evaluated based on the INS readings. It is assumed that the sampling frequency Fₛ used by the INS is sufficiently high and the corresponding sampling interval Tₛ is sufficiently small. The numerical integration step derived from the INS readings can then be approximated by an infinitesimal integration step: Δ\overline{\tilde{x}}≅d\overline{\tilde{x}}. The evaluation of the scalar potential then becomes:

\tilde{ψ}=∫_{S}\overline{\tilde{H}}·d\overline{\tilde{x}}

And the estimated magnetic field is the measured magnetic field rotated to the navigation frame by the estimated body to Earth rotation matrix (equation 2):

\overline{\tilde{H}}=\tilde{R}_{be}·H̅_{b}^{meas}

The integration step as derived from the INS readings is the true integration step plus some small error:

d\hat{x}=dx+d\hat{x}

This integration step error depends on the INS velocity error. As \overline{\tilde{H}}≈H̅, the evaluated scalar potential becomes:

\tilde{ψ}=∫_{S}\overline{\tilde{H}}·d\overline{\tilde{x}}≈∫_{S}H̅·dx̅+∫_{S}H̅·d\overline{\hat{x}}

The first part of the right hand side is the evaluation of the integral over the true path S and the true magnetic field strength and is identical to ψ^{end}.

\tilde{ψ}=ψ^{end}|∫_{S}H̅·d\overline{\hat{x}} (4)

The rightmost part of the right hand side is the deviation of ψ^{end} due to the INS errors. d\overline{\hat{x}} is an error that only depends on the velocity error and changes during the time interval T.

In the absence of aiding information, d\overline{\hat{x}} changes due to a linear combination of two primary effects. Each of these effects will be analyzed individually:

Effect 1: a constant velocity error. Due to constant velocity errors (the starting value) the position error grows linearly. For this effect, d\overline{\hat{x}} can be written as:

d\overline{\hat{x}}=\overline{\hat{V}}·dt. (5)

We use a capital \overline{\hat{V}}to distinguish it from the INS velocity error \overline{\hat{V}}. The INS velocity error is not constant but when other aiding information stops, it starts at \overline{\hat{V}}and then grows due to the constant attitude errors.

Effect 2: a constant attitude error. Constant attitude errors result in constant acceleration errors via gravity compensation. Due to constant acceleration errors, velocity errors are growing linearly. This has an exponential effect on the position error. For this effect, d\overline{\hat{x}} can be written as:

d\overline{\hat{x}}=\overline{\hat{α}}·t·dt (6)

The combined effect is:

d\hat{x}=(\overline{\hat{V}}+\hat{α}·t) (7)

Substituting in equation 4:

\tilde{ψ}=ψ^{end}+∫_{O}^{T}H̅·(\overline{\hat{V}}+\overline{\hat{α}}·t)·dt

\tilde{ψ}=ψ^{end}+{∫_{O}^{T}H̅\overline{\hat{V}}·dt}+{∫_{O}^{T}H̅·\overline{\hat{α}}·t·dt} (8)

In which the two different effects are expressed between the two sets of braces. Because of the substitution, integration is now done over time instead of distance. T is the total integration time.

It is noted that the number of effects can in principle be extended to a third effect, the gyro bias errors b̅_{g}, resulting in:

d\overline{\hat{x}}=b̅_{g}·½t²·dt

Constant gyro bias errors are however assumed to be compensated by the technology disclosed in US2014005975, which document is herewith incorporated in this document.

It is further noted that a constant INS position error cannot be resolved using this method as d\overline{\hat{x}}=O, so \overline{\hat{p}}^{end} is the position error growth during the interval T.

When analyzing effect 1, the first effect of a constant velocity error on the scalar potential is considered. Substituting equation 5 in equation 4, the evaluated scalar potential becomes:

$$\begin{matrix}\tilde{ψ} = {ψ}^{end} + {\int }_{0}^{T} \overline{H} \cdot \hat{\overline{V}} \cdot d t \\ = {ψ}^{end} + \hat{\overline{V}} \cdot {\int }_{0}^{T} \overline{H} \cdot d t \\ = {ψ}^{end} + \hat{\overline{V}} \cdot T \cdot \frac{1}{T} {\int }_{0}^{T} \overline{H} \cdot d t\end{matrix} \qquad ( 9 )$$

Again T is the duration of the time interval. \overline{\hat{V}}·T is equal to the INS error growth \overline{\hat{p}} if constant velocity errors are the only cause of the position error growth:

\overline{\hat{p}}−\overline{\hat{V}}·T (10)

Further,

$$\frac{1}{T} {\int }_{0}^{T} \overline{H} \cdot d t$$

is the time-averaged value of the magnetic field strength during the interval T.

$${\overline{H}}^{avg} = \frac{1}{T} {\int }_{0}^{T} \overline{H} \cdot d t$$

Substituting these in equation 9, the equation for the evaluated scalar potential becomes:

\tilde{ψ}=ψ^{end}+\overline{\hat{p}}·H̅^{avg}

Subtracting equation 3 from this equation:

\tilde{ψ}−ψ^{table}(\tilde{p̅}^{end})=(ψ^{end}+\overline{\hat{p}}·H̅^{avg})−(ψ^{end}+H̅^{end}·\overline{\hat{p}}·H̅^{avg}−H̅^{end}

\tilde{ψ}−ψ^{table}(\tilde{p̅}^{end})=(H̅^{avg}−H̅^{end})·\overline{\hat{p}} (11)

This results in a measurement equation for the Kalman filter, that relates the INS error \overline{\dot{p}}, given a constant velocity error, to a measurement r̅=\tilde{ψ}−ψ^{table}(\tilde{p̅}^{end}), and can be implemented in a standard navigation filter structure as shown in FIG. 2. The term between the parenthesis can be evaluated during navigation and is therefore known.

As an alternative, it is also possible to directly relate the constant velocity error and the INS position error to the measured scalar potential difference. Subtracting equation 3 from equation 9, results in:

\tilde{ψ}−ψ^{table}(\tilde{p}^{end})=(ψ^{end}+\hat{V}·∫_{O}^{T}H·dt)−(ψ^{end}+H^{end}·\overline{\tilde{p}})

\tilde{ψ} ψ^{table}(\tilde{p̅}^{end})=\overline{\hat{V}}·∫_{O}^{T}H̅·dt H̅^{end}·\overline{\hat{p}} (12)

Again, a measurement equation is obtained. ∫₀^{T}H̅·dt and H̅^{end} are both known and can be calculated during navigation.

When analyzing effect 2, a comparable equation is obtained for constant acceleration errors (due to attitude). Substituting equation 6 in equation 4 results in:

\tilde{ψ}=ψ^{end}+∫_{O}^{T}H̅·\overline{\hat{α}}·t·dt=ψ^{end}+\overline{\hat{α}}·∫_{O}^{T}H̅·t·dt (13)

For constant acceleration errors, the effect on the position error is:

\overline{\hat{p}}=₂¹\overline{\hat{α}}T², or \overline{\hat{α}}=\overline{\hat{p}}_{T}_{²}² (14)

Substituting this in equation 13 results in:

$$\tilde{ψ} = {ψ}^{end} + \hat{\overline{p}} \cdot \frac{2}{{T}^{2}} {\int }_{0}^{T} \overline{H} \cdot t \cdot d t \qquad ( 15 )$$

Subtracting equation 3 from this:

$$\tilde{ψ} - {ψ}^{table} ( {\overline{\tilde{p}}}^{end} ) = ( {ψ}^{end} + \overline{\tilde{p}} \cdot \frac{2}{{T}^{2}} {\int }_{0}^{T} \overline{H} \cdot t \cdot d t ) - ( {ψ}^{end} + {\overline{H}}^{end} \cdot \hat{\overline{p}} ) \\ \tilde{ψ} - {ψ}^{table} ( {\overline{\tilde{p}}}^{end} ) = ( \frac{2}{{T}^{2}} {\int }_{0}^{T} H \cdot t \cdot d t - {\overline{H}}^{end} ) \cdot \hat{\overline{p}} \qquad ( 16 )$$

This results in a measurement equation for the Kalman filter that relates the INS error \overline{\tilde{p}}, given a constant acceleration error (or corresponding attitude error), to a measurement r̅=\tilde{ψ}−ψ^{table}(\tilde{p̅}^{end}), and can be implemented in a fairly standard navigation filter structure as shown in FIG. 2. The term between the parenthesis can be evaluated during navigation and is therefore known.

For this effect an alternative measurement equation also exists. Subtracting equation 3 from equation 13 results in:

\tilde{ψ}−ψ^{table}(\tilde{p̅}^{end})=(ψ^{end}+\overline{\hat{α}}·∫_{O}^{T}H̅·t·dt)−(ψ^{end}+H̅^{end}·\overline{\hat{p}})

\tilde{ψ}−ψ^{table}(\tilde{p̅}^{end})=\overline{\hat{α}}·∫_{O}^{T}H̅·dt H̅·t·dt−\overline{\hat{p}}·H̅^{end} (17)

∫_{O}^{T}H̅·t·dt and H̅^{end} are known and can be evaluated during navigation.

Although gyro bias errors are assumed to be compensated by the technology disclosed in US2014005975, which is herewith incorporated in this document in its entirety, its effect can also be observed. Only for completeness, it is briefly discussed here. For this third effect, equation 4 likewise becomes:

$$\begin{matrix}\tilde{ψ} = {ψ}^{end} + {\int }_{0}^{T} \overline{H} \cdot {\overline{b}}_{g} \cdot \frac{1}{2} {t}^{2} \cdot d t \\ = {ψ}^{end} + \frac{1}{2} {\overline{b}}_{g} \cdot {\int }_{0}^{T} \overline{H} \cdot {t}^{2} \cdot d t\end{matrix}$$

$$Substituting \hat{\overline{p}} = \frac{1}{c} {\overline{b}}_{g} {T}^{3} \text{:}$$

$$\tilde{ψ} = {ψ}^{end} + \hat{\overline{p}} \cdot \frac{\hat{o}}{{T}^{3}} {\int }_{0}^{T} \overline{H} \cdot {t}^{2} \cdot d t$$

As mentioned before, d\overline{\hat{x}}is a linear combination of these effects, resulting in a general expression for the measurement equation. It can be written as a combined measurement equation that directly relates an evaluated difference in scalar potential to the INS position error growth, a constant velocity term and a constant acceleration term.

Repeating equation 8:

\tilde{ψ}=ψ^{end}+{∫_{O}^{T}H̅·\overline{\hat{V}}·dt}+{∫_{O}^{T}H̅·\overline{\hat{α}}·t·dt}

Substract equation 3 and rearranging:

\tilde{ψ}−ψ^{t} (\tilde{p̅}^{e})−\overline{\hat{V}}·(∫_{O}^{T}H̅·dt)+û̅·(∫_{O}^{T}H̅·t·dt)−\overline{\hat{p}}·(H̅^{end}) (18)

This results in a measurement equation that relates the constant velocity error, constant INS attitude error and INS position error growth to an evaluated difference in scalar potential. The terms between the parenthesis are known and can be evaluated during navigation. This expression can likewise be extended to further include the gyro bias.

Further substituting equations 10 and 14 results in:

$$\tilde{ψ} - {ψ}^{t} ( {\overline{\tilde{p}}}^{e} ) = ( \frac{1}{τ} {\int }_{0}^{T} \overline{H} \cdot d t + \frac{2}{{τ}^{2}} {\int }_{0}^{T} \overline{H} \cdot t \cdot d t - {\overline{H}}^{end} ) \cdot \hat{\overline{p}} \qquad ( 19 )$$

This results in a measurement equation that relates an evaluated difference in scalar potential to the INS position error growth, given all the combined effects. The term between the parenthesis is known and can be evaluated during navigation. This expression can also be extended to further include the gyro bias.

In summary, a general expression (equation 19) is found for a measurement equation that relates a difference in scalar potential to the INS position error growth. This general expression has the form:

Δ_{ψ}=\overline{\hat{p}}·C₀(T)

in which Δψ is the evaluated difference in scalar potential. C₀(T), is a constant, given an integration time T.

An alternative general expression (equation 18) for a measurement equation is found that relates a difference in scalar potential to the INS position error growth, a constant velocity error and a constant acceleration error. This general expression has the form:

Δ_{ψ}=\overline{\hat{p}}·C₁(T)+\overline{\hat{V}}·C₂(T)+\overline{\hat{α}}·C₂(T)

The constant velocity error \overline{\hat{V}}is not the same as the (varying) INS velocity error \overline{\hat{V}}.

Therefore, use of this form of measurement equation requires an additional state for the constant velocity error \overline{\hat{V}}to be estimated by the Kalman filter.

It is noted that observability of the INS error sources depends on the amount of variation of the magnetic field. If the magnetic field is completely homogeneous, error sources are not observable. Correction may be postponed until a variation in the magnetic field is detected.

During a trajectory (also referred to as path), the magnetic field can be compared with the expected magnetic field by looking it up in a table. If the difference exceeds a threshold, INS correction can be omitted (if other sensors are available), or postponed until the magnetic field is as expected.

Because the magnetic field is known beforehand, the evaluation period T can be taken such that maximum observability is achieved.

The navigation device 1 shown merely by way of non-limiting example in

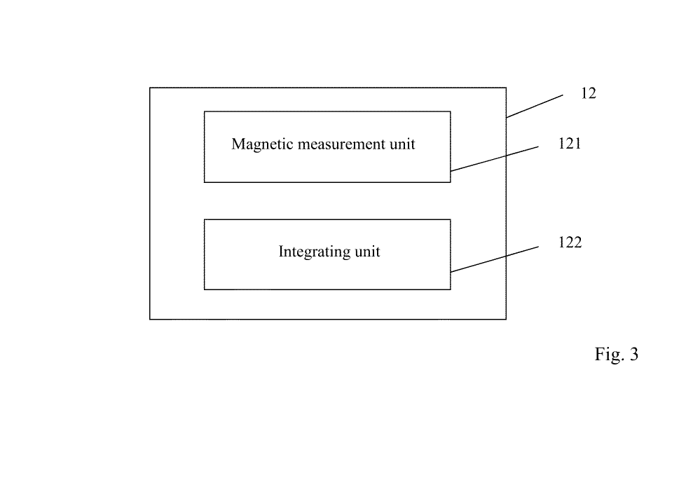

FIG. 2 comprises a navigation state estimation unit 11, a prediction unit 12, a storage unit 13, a subtraction unit 14, a filter unit 15, and a correction unit 16. In the embodiment shown, the navigation state estimation unit 11 is constituted by an INS (Inertial Navigation System) unit which produces an estimated navigation state comprising an estimated position, an estimated velocity and an estimated attitude. The estimated position is fed to the storage unit 13 to retrieve a stored magnetic property value (Ψ). According to the present invention, this magnetic property value is the integral over distance of the magnetic field strength from a reference point to the current position. Using the estimated position, the prediction unit 12 produces a predicted magnetic property value, as will be explained later in more detail with reference to FIG. 3. If the predicted and the retrieved magnetic property values are identical, then the navigation error is apparently zero and no correction is required. Only rarely, it may occur that the magnetic field over the part of the trajectory is uniform, in which cases no correction can be applied.

Normally, however, the predicted and the retrieved magnetic property values are not identical. Their values are compared in the subtraction unit 14, which produces their difference r which is output to the filter unit 15. The subtraction unit 14 is preferably further configured for detecting two special conditions:

a. The difference of the predicted and the retrieved magnetic property values is smaller than a first threshold, meaning that they are practically identical; and

b. The difference of the predicted and the retrieved magnetic property values is greater than a second threshold, meaning that these values diverge more than expected.

When either condition is met, special measures may be taken, as will later be discussed in more detail.

In the embodiment shown in FIG. 2, the filter unit 15 comprises a Kalman filter, which may be known per se. Using the difference of the predicted and the retrieved magnetic property values, the filter unit 15 produces a correction value which is fed to the correction unit 16, which in turn uses the correction value to correct the estimated navigation state produced by the navigation state estimating unit and to produce a corrected navigation state estimate. In the embodiment shown, the correction unit 16 uses subtraction to correct the navigation state, but other correction mechanisms, such as multiplicative correction, may also be used, provided a suitable correction value is used. As a standard practice the INS may regularly be reinitialized to the corrected states to avoid large navigation state errors.

It will be understood that the storage unit 13 preferably comprises a ROM (Read Only Memory) or similar data storage. The storage unit 13 may be physically present in the vehicle in which the device is used, or may be a remote storage with data communication facilities.

When condition a. above is met, meaning that the predicted and the retrieved magnetic property values are identical or nearly identical, the updating process of the Kalman filter may be suspended in order to preserve the filter's internal states. This suspension ends when the first threshold is exceeded again.

When condition b. above is met, meaning that the predicted and the retrieved magnetic property values are too different to allow a regular correction, the updating process of the Kalman filter may also be suspended.

The prediction unit 12 schematically illustrated in FIG. 3 comprises a magnetic measuring unit 121 and an integrating unit 122. The magnetic measuring unit 121 measures the magnetic field H during the course of a trajectory. Preferably, the magnetic field is measured at suitable sampling intervals, which may be expressed in time and/or distance. The measured magnetic field values are fed to the integration unit 122, which integrates these values over distance so as to produce the magnetic property value of the present invention, using for example \tilde{ψ}=∫_{S}\overline{\tilde{H}}·d\overline{\tilde{x}} as explained above. The thus produced “predicted” magnetic property values are then fed to the subtraction unit 14, where they are compared with the “expected” magnetic property values retrieved from the storage unit 14.

The present invention is based upon the insight that navigation errors can be corrected using partial integrals over distance of the magnetic field, and that comparing such integrals during use with previously made integrals allows navigation corrections to be made. Use of the integrals, instead of the magnetic field measurements, allows for the seamless integration with other sensors in integrated navigation systems as described in detail in Groves.

The present invention can advantageously be used together with the invention disclosed in US patent application US2014005975 and its European counterpart EP2678637 (TNO file PLT 2011 015), both of which are herewith incorporated in this document. More in particular, the present invention can advantageously be combined with a measuring device and/or method for measuring a vectorial physical quantity, comprising the steps of
measuring a component of the vectorial physical quantity with at least a first and a second sensor therewith generating a respective sense signal respectively, said sense signals each including a first part indicative for the component of the measured quantity and a second, noise part, said sensors having an Allan variance curve with a minimum value for a particular integration time, said Allan variance curve having a first tangent line to a portion of the curve for which the integration time approaches zero, and having a second, horizontal, tangent line of constant standard deviation corresponding to said Allan minimum value, said first and said second tangent line having an intersection point for a second particular integration time,
causing a relative rotation between said at least a first and a second sensor,
providing a difference signal indicative for a weighted difference between the sense signals, said weighted difference being substantially independent of the vectorial physical quantity, comprising the steps of
weighting the sense signals dependent on the relative rotation to provide mutually weighted sense signals, the signal weighting unit having at least one multiplication unit for multiplying one of the sense signals with a weighting factor,
providing a difference signal indicative for a difference between the mutually weighted sense signals,
estimating a correlated low frequency noise component from the difference signal and from information about the relative rotation between the sensors and for generating an estimated noise signal indicative for the estimated value of said noise component, said low frequency noise estimation having an associated effective integration time that is at least two times a sample time with which the sense signals are obtained, which effective integration time is less than the smallest particular integration time of the sensors comprised in the measuring device and which effective integration time is at most two times said second integration time,
providing an output signal indicative for a sensed value of the vectorial physical quantity corrected for the noise as estimated by said low frequency noise estimation.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A navigation device, comprising:
a navigation state estimation unit for repeatedly providing a navigation state estimate,
a prediction unit for providing, using the navigation state estimate, a predicted magnetic property value,
a storage unit for retrieving, using the navigation state estimate, a previously stored magnetic property value,
a subtraction unit for producing the difference of the predicted magnetic property value and the retrieved magnetic property value,
a filter unit for producing, using said difference, a navigation state correction value, and
a correction unit for correcting, using said navigation state correction value, a corrected navigation state estimate,
wherein the prediction unit comprises:
a magnetic measuring unit for repeatedly providing a measured magnetic field strength value, and
an integrating unit for integrating the measured magnetic field strength values to produce the magnetic property value corresponding with the navigation state estimate.

2. The device according to claim 1, wherein the filter unit comprises a Kalman filter, which Kalman filter is preferably updated when producing each navigation state correction value.

3. The device according to claim 1, wherein the filter unit is not updated if the difference of the predicted magnetic property value and the retrieved magnetic property value substantially equals zero.

4. The device according to claim 1, wherein the filter unit is not updated if the difference of the predicted magnetic property value and the retrieved magnetic property value exceeds a threshold value.

5. The device according to claim 1, wherein the magnetic measuring unit is configured for determining variations in the magnetic field, and preferably for halting the correcting of the navigation state estimate if the variations fail to exceed a threshold value.

6. The device according to claim 1, wherein the difference of the predicted magnetic property value and the retrieved magnetic property value is given by \tilde{ψ}−ψ^{table}(\tilde{p̅}^{end})=(H̅^{avg}−H̅^{end})·\overline{\hat{p}} where H^{avg} is the average magnetic field strength during a measurement trajectory, H̅^{end} is the magnetic field strength at the end of the measurement trajectory, and \overline{\hat{p}} is the estimated navigation state error.

7. The device according to claim 1, wherein the difference of the predicted magnetic property value and the retrieved magnetic property value is given by
\tilde{ψ}ψ^{t}(\tilde{p̅}^{e})=\overline{\hat{V}}·(∫_{O}^{T}H̅·dt)+\overline{\hat{α}}·(∫_{O}^{T}H̅·t·dt)−\overline{\hat{p}}·(H̅^{end}),
where \overline{\hat{V}}is the estimated velocity error, H̅ is the magnetic field strength during a measurement trajectory, H̅^{end} is the magnetic field strength at the end of the measurement trajectory, α is the acceleration error, and \overline{\hat{p}} is the estimated navigation state error.

8. The device according to claim 1, wherein the navigation state estimation unit is configured for inertial navigation.

9. A vehicle, comprising a navigation device according to claim 1.

10. A set of vehicles arranged for data exchange, the vehicles together comprising all constituent units of the navigation device according to claim 1, a first vehicle comprising the magnetic measuring unit and a second vehicle comprising the navigation state estimation unit.

11. A set of vehicles according to claim 10, wherein the magnetic measuring unit of said first vehicle is part of a first navigation device comprised in the first vehicle, and wherein the navigation state estimation unit of the second vehicle is part of a second navigation device comprised in the second vehicle, said second navigation device comprising:
a navigation state estimation unit for repeatedly providing a navigation state estimate,
a prediction unit for providing, using the navigation state estimate, a predicted magnetic property value,
a storage unit for retrieving, using the navigation state estimate, a previously stored magnetic property value,
a subtraction unit for producing the difference of the predicted magnetic property value and the retrieved magnetic property value,
a filter unit for producing, using said difference, a navigation state correction value, and
a correction unit for correcting, using said navigation state correction value, a corrected navigation state estimate,
wherein the prediction unit comprises:
a magnetic measuring unit for repeatedly providing a measured magnetic field strength value, and
an integrating unit for integrating the measured magnetic field strength values to produce the magnetic property value corresponding with the navigation state estimate,
wherein said magnetic measuring unit of said first vehicle determines magnetic property values for storage in said storage unit of said second navigation device, to be used by the subtraction unit of the second navigation device for producing the difference of the predicted magnetic property value and the retrieved magnetic property value.

12. A navigation method comprising the steps of:
repeatedly providing a navigation state estimate,
providing, using the navigation state estimate, a predicted magnetic property value,
retrieving, using the navigation state estimate, a previously stored magnetic property value,
producing the difference of the predicted magnetic property value and the retrieved magnetic property value,
producing, using said difference, a navigation state correction value, and
correcting, using said navigation state correction value, a corrected navigation state estimate,
wherein the step of providing a predicted magnetic property value comprises:
repeatedly providing a measured magnetic field strength value, and
integrating the measured magnetic field strength values to produce the magnetic property value corresponding with the navigation state estimate.

13. The method according to claim 12, wherein the step of producing a navigation state correction value comprises Kalman filtering, which Kalman filtering preferably comprises updating a filtering state when producing each navigation state correction value.

14. The method according to claim 13, wherein the Kalman filtering state is not updated if the difference of the predicted magnetic property value and the retrieved magnetic property value substantially equals zero.

15. The method according to claim 12, wherein the previously stored magnetic property values are obtained by repeatedly providing a measured magnetic field strength value, and integrating the measured magnetic field strength values.

16. The method according to claim 15, wherein the step of repeatedly providing a measured magnetic field strength value is carried out in a first vehicle, and wherein the other steps are carried out in a second vehicle, the values being transmitted from the first to the second vehicle, the second vehicle preferably following the first vehicle.

17. The method according to claim 12, wherein the difference of the predicted magnetic property value and the retrieved magnetic property value is given by \tilde{ψ}−ψ^{table}(\tilde{p̅}^{end})=(H̅^{avg}−H̅^{end})·\overline{\hat{p}}, where H^{avg} is the average magnetic field strength during a measurement trajectory, H̅^{end} is the magnetic field strength at the end of the measurement trajectory, and \overline{\hat{p}} is the estimated navigation state.

18. The method according to claim 12, wherein the difference of the predicted magnetic property value and the retrieved magnetic property value is given by
\tilde{ψ}−ψ^{t}(\tilde{p̅}^{e})=\overline{\hat{V}}·(∫_{O}^{T}H̅·dt)+\overline{\hat{α}}·(∫_{O}^{T}H̅·t·dt)−\overline{\hat{p}}·(H̅^{end}),
where \overline{\hat{V}} is the estimated velocity, H̅ is the magnetic field strength during a measurement trajectory, H̅^{end} is the magnetic field strength at the end of the measurement trajectory, a is the acceleration, and \overline{\hat{p}} is the estimated navigation state.

19. A computer program product for carrying out the method according to claim 12.
